(19) United States
(12) Patent Application Publication
(10) Pub. No.: US 2017/0091799 A1
(43) Pub. Date: Mar. 30, 2017

(54) Social Challenge System and Method

(71) Applicant: Daniel John Visser, McKinney, TX (US)

(72) Inventor: Daniel John Visser, McKinney, TX (US)

(21) Appl. No.: 15/277,681

(22) Filed: Sep. 27, 2016

Related U.S. Application Data
(60) Provisional application No. 62/233,420, filed on Sep. 27, 2015.

(51) Int. Cl. G06Q 30/02; G06Q 50/00

(52) U.S. Cl. CPC G06Q 30/0209; G06Q 50/01

(57) ABSTRACT

A challenge system comprising a host server connected via a network to a set of participant devices enable the set of participants to act as a set of challengers and a set of challengees in a social media forum. The host server includes a database and is configured to facilitate the creation and dissemination of a challenge from a challenger and to facilitate the acceptance of challenges from a challengee. The challenge is related to an event such as a sporting event or group event and includes a payout requirement. The payout requirement can be a non-monetary requirement such as a requirement for a participant to perform a particular action. The challenge system verifies winners and losers of the challenge and verifies the payout requirement. A challenge process can be performed on a public forum and includes posting of advertisements related to a challenge or challenge payout.

### FIELD OF THE INVENTION

The present invention relates to systems and methods for an online social challenge system. In particular, the present invention relates to systems and methods for arranging and verifying social challenges between participants.

### SUMMARY OF THE INVENTION

Described herein is a daily fantasy sports themed system designed for anyone (challenger) to challenge other people (challengees) in daily win or lose “pick'em” games or other events with payouts that are uniquely different than existing art.

Popular daily sports themed fantasy sites are money driven (Fanduel.com, Draftkings.com). People play at these sites to compete against many other players in order to win money. The present system, hereafter referred to as Wicked Wager (WW) or the “challenge system”, is different from these sites in several distinct ways. WW is based on the concept of social challenges made between participants. A social challenge results in a participant having to do something (called a “payout”) that may or may not hurt their pride and integrity (eg. wear the jersey of your friend's favorite NFL team to work). There are no monetary winnings or prizes for challenges.

A challenge is usually one participant vs. another participant but is not limited to one vs. one interaction. There may be one or more participants acting as a challenger and one or more participants acting as the challengee. WW challenges are not rigid, they are malleable and negotiable. For example, WW includes the ability to craft a sports challenge based on the score of a first/second half, quarter, inning, or period, of a game. Furthermore, the present system facilitates challengers and challengees the ability to change and negotiate the payout before coming to an agreement.

WW is also unique in that it does not pool players to compete against one another. A challenge within WW, between a challenger and a challengee, is designed to be personal and reflect the passion and loyalty fans have for their team and their willingness to put something more valuable on the line than money: their respect and dignity.

WW offers a unique way to make a challenge between participants tangible. To complete a challenge, WW performs a “Social Media Verification”. For example, when a challenge is created, the challenger requires that the winner of the challenge submit a pic, tweet, vine, Instagram, or YouTube (Any Social Media source) video of the “payout” event. In turn the “Social Media Verification” is communicated by WW to a social group associated with the challenger and challengee.

Some challenges are specifically designed to allow people to connect, meet, and add spice to relationships using professional sports as a catalyst. These are called “Relationship Challenges”. Users send these challenges as an icebreaker with someone they would like to get to know better. WW can be used as a fun and innovative way to move a friendly relationship to a deeper level. The invention provides for a completely new type of social dating interaction that does not exist today. WW can also be used as a relationship barometer, in that a personal payout challenge can be sent in hopes that the challengee will accept, thereby confirming the challengee's interest.

The embodiments presented herein utilize a website or a mobile app interacting with a host over the internet to manage challenges and payouts. Using a website and/or mobile app interface is a new way to bring sports fans, friends, and family together in fun and creative challenges, each challenge uniquely individual with motives that are uniquely individual. However, the inventive concepts should not be limited to the embodiments presented.

### BRIEF DESCRIPTION OF THE DRAWINGS

In the detailed description presented below, reference is made to the accompanying drawings.

FIG. 1 is a schematic of a social game system of a preferred embodiment.

FIG. 2 is a flow diagram of a primary method of a preferred embodiment.

FIG. 3A is a flow diagram of event scheduling of a preferred embodiment.

FIG. 3B is a flow diagram of challenge formation of a preferred embodiment.

FIG. 3C is a flow diagram of participant profiling of a preferred embodiment.

FIG. 3D is a flow diagram of odds analysis of a preferred embodiment.

FIG. 3E is a flow diagram of social media verification of a preferred embodiment.

FIG. 3F is a flow diagram of a public challenge method of a preferred embodiment.

FIG. 3G is a flow diagram of participant grouping.

FIG. 4 is a sequence diagram of a preferred embodiment.

FIG. 5A is a sequence diagram of challenge agreement.

FIG. 5B is a sequence diagram of a challenge agreement with a counter challenge in an alternate embodiment.

FIG. 6 is schematic block diagram of a challenge in a preferred embodiment.

FIG. 7 is a sequence diagram of an alternate embodiment including a public challenge.

### DETAILED DESCRIPTION

It will be appreciated by those skilled in the art that aspects of the present disclosure may be illustrated and described in any of a number of patentable classes or contexts including any new and useful process or machine or any new and useful improvement.

Computer program code for carrying out operations of the challenge system may be written in any combination of one or more programming languages, including an object oriented programming language such as Java, C++, C#, .NET, Objective C, Ruby, Python SQL, or other modern and commercially available programming languages. To carry out the operations of the challenge system, the computer program code is stored in the memory of computers and servers and further executed on the processors of the computers and servers as described below.

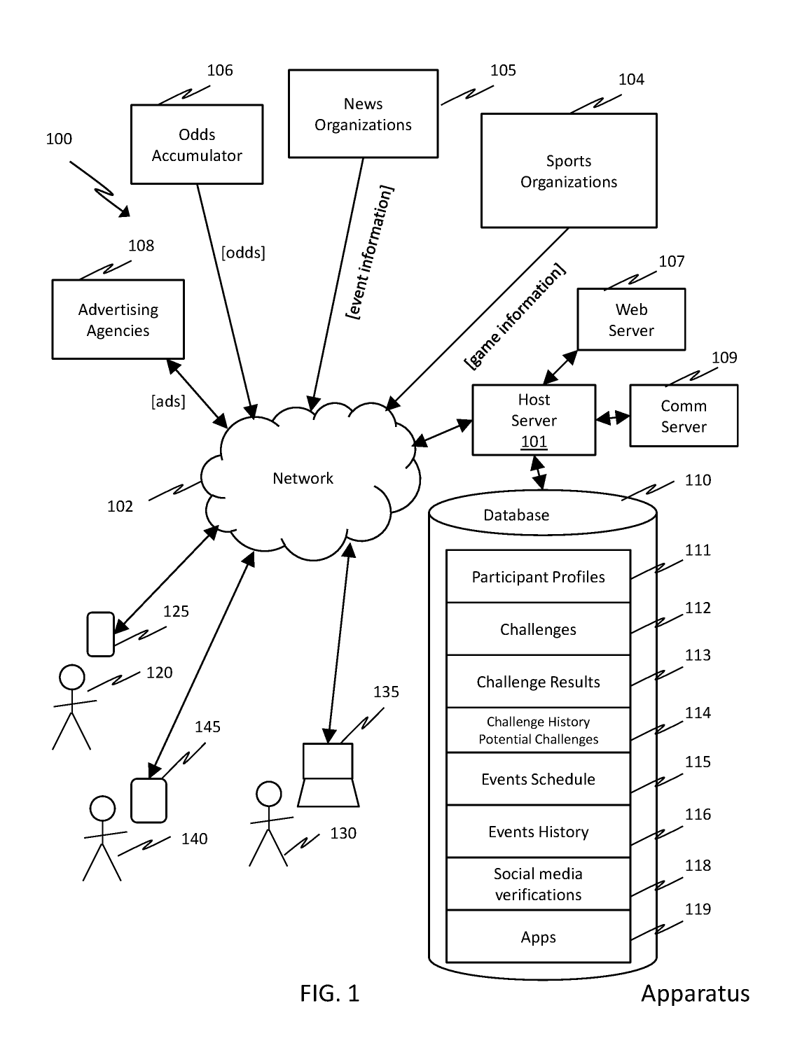

Referring to FIG. 1, system 100 includes host server 101, network 102, database 110 and a set of user devices (125, 135, and 145) for a set of participants (120, 130 and 140), each of which is connected to host server 101 through network 102. Host server 102 is further connected to database 110 for storage of relevant data. In a preferred embodiment host server includes a web site server 107 and a communications server 109 for managing email and messaging transactions (e.g. SMS or Facebook messaging).

For exemplary purposes, the set of user devices comprise a mobile handheld device 125 for participant 120, a desktop device 135 for participant 130 and a tablet device 145 for participant 140. Each of participants 120, 130 and 140 is an in active participant registered by the host system or a passive participant which is not registered by the host system. In a preferred embodiment, each of the user devices communicates with host server 101 via a web browser to create, manage, communicate and verify social challenges by active participants as described further below. An active participant or a passive participant simply receive challenges as will be further described below. In an alternate embodiment, a programmed computer application (mobile app) in communication with the host server is resident on the set of user devices. The mobile app may be distributed by the host server to the set of user devices over the network 102.

Referring further to FIG. 1, host server 101 is further connected to external data sources including sports organizations 104, news organizations 105 and odds accumulator 106. Host server 101 receives game schedules and game results from sports organization 104. Game results may include partial game results and player information such as quarter by quarter scoring summaries, player batting averages, pitcher ERAs, quarterback ratings, and so forth. Host server 101 receives event information from news organizations 105. Event information may include any information related to an event including time and place data, polling data, election results, celebrity status and so forth. Host server 101 receives odds information from odds accumulator 106. Odds information includes results of odds analysis related to the prediction of an outcome of a sports or other event useful for helping participants select games and events.

In a preferred embodiment, host server 101 is communicatively connected to advertising agencies 108 for receiving and displaying advertisements to participants based on participant profiles or for receiving and displaying general website advertisements to all participants on a web site.

Referring further to FIG. 1, database 110 includes electronic storage and retrieval of information relevant to challenges comprising, but not limited to, participant profiles 111, challenges 112 including challenge detail information, challenge results 113, challenge history 114, events schedule 115, events history 116 and social media verifications 118. Challenge history 114 comprises challenge information suitable to create a new challenge as a duplicate of a previous challenge. Challenge results 118 include the outcome of each challenge. Events history 116 includes the outcome of historical events. Social media verifications 118 includes social media links, photographs, textual data and other evidence of “payout” to challenges.

Optionally, database 110 includes a set of mobile apps 119 for distributing to and installing on the set of user devices. A mobile app, in the set of mobile apps 119, is computer readable code which, when executed by a processor of a user device, transforms the user device into a hardware specific extension of the host server to interact with each participant.

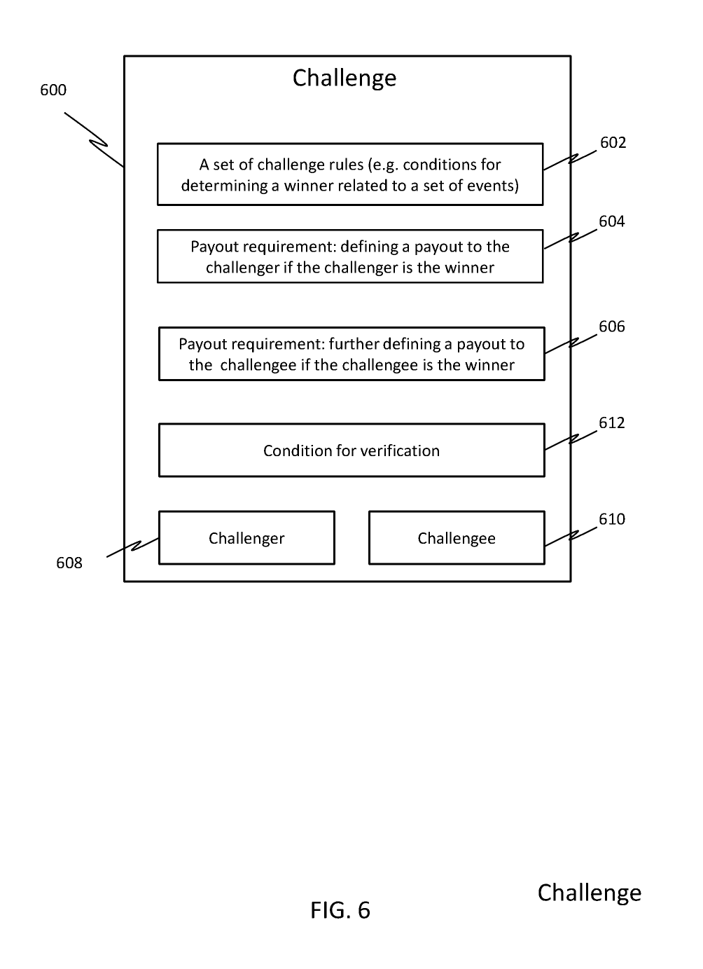

Referring to FIG. 6, a preferred embodiment of a challenge is described. Challenge 600 comprises a challenger 608 and a challengee 610. The challenger is the initiator of the challenge and can be a set of one or more participants. The challengee can be a set of one or more participants that are mutually exclusive of the challenger. Challenge 600 further comprises a set of challenge rules 602. At minimum, the set of challenge rules include a condition for determining a winner between the challenger and the challengee. While the set of challenge rules are generally intended to define a condition related to the outcome of a set of sports games or a set of events, it can also include other conditions, for example, a profile for potential challengees or a set of actions to be completed by the challenger and the potential challengees. Challenge 600 further comprises payout requirements payout 604 and payout 606. A payout 604 is payable to the challenger if the challenger is the winner. The payout to the challenger is typically an action to be performed by the challengee. The payout will include the detailed description of a required action. Challenge 600 further comprises a payout 606 which is payable to the challenger if the challengee is the winner. The payout to the challengee is typically an action to be performed by the challenger.

Challenge 600 further comprises a condition for verification 612. A condition for verification, for example, is a condition that the verification is achieved by proxy vote from non-participants, or from a single vote by the winner or from both a proxy vote and a winner vote.

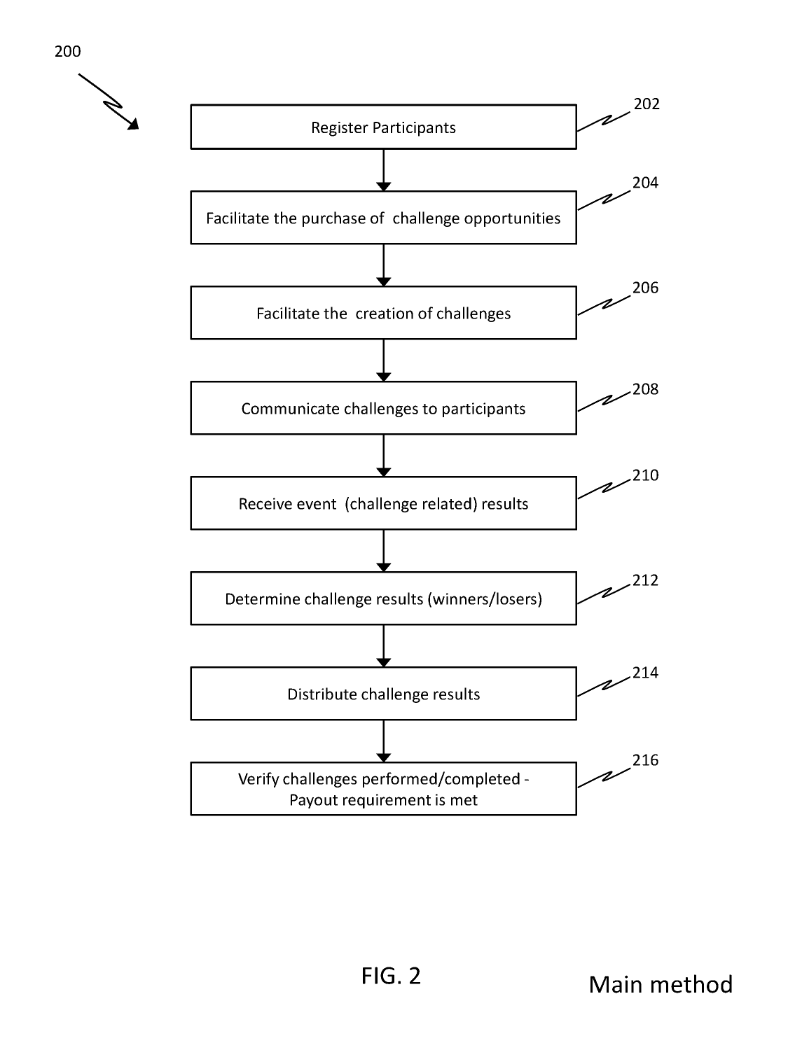

Referring to FIG. 2, a method 200 of operation is shown. Method 200 is implemented by the present system on a host server, for example, the challenge system described in FIG. 1. Optionally, some aspects of method 200 are implemented by the set of user devices using the set of mobile apps executed by individual processors of the set of user devices. The steps of method 200 are not necessarily in a chronological order.

At step 202, the challenge system registers participants. The registration typically includes the creation of a profile for a participant including a user name and password at minimum. Other profile information may be collected such as mobile phone numbers, locations, and participant specific data (e.g. hair color, eye color, height, weight, hobbies and so forth).

At step 204, the challenge system facilitates the purchase of challenges. In a preferred embodiment, one or more opportunities to challenge are monetarily purchased. To facilitate the purchase of challenges, any number of purchasing mechanisms, as are known in the art, may be employed including, for example, credit card, bank transfer, Pay Pal, and so forth.

At step 206, the challenge system facilitates the creation of challenges.

At step 208, the challenge system communicates challenges from challengers to challengees, Challengers are registered participants who are initiators, creators or selectors of challenges. Challengees are those registered participants and non-registered participants to whom the challenges are directed in a communication facilitated by the host server.

At step 210, the challenge system receives event results which include sports event results and news event results related to challenges.

At step 212, the challenge system determines winners (and also losers) of each challenge based on the event results and the challenge detail of the challenge.

At step 214, the challenge system distributes challenge results to participants including the challenger and challengee. In a preferred embodiment, the challenge results are sent directly to the challenger and challengee using a personal communication method including, but not limited to, email, text message and a social media messenger (e.g. Facebook). In an alternate embodiment, the challenge results are sent directly to the challenger and challengee, but are also posted on a public website of the web server operated by the host server, the public website being made accessible by non-participant viewers. The challenge results include a description of the winner and loser of the challenge and also include the payout results for verifying and showing that a payout requirement was met.

At step 216, the challenge system verifies that challenges were performed as agreed upon in the challenge by collecting evidence of completion including digital information such as links to social media postings, photographs, textual descriptions and so forth. The evidence of completion is included in the challenge history in the database. In an alternate embodiment, the challenge system sends a survey form to the challenger and challenge to specifically verify that the challenge was completed and that a payout requirement was met. The challenge system also receives the survey form and stores it in the challenge history. The challenge system will also distribute payout verification with the challenge results in step 214.

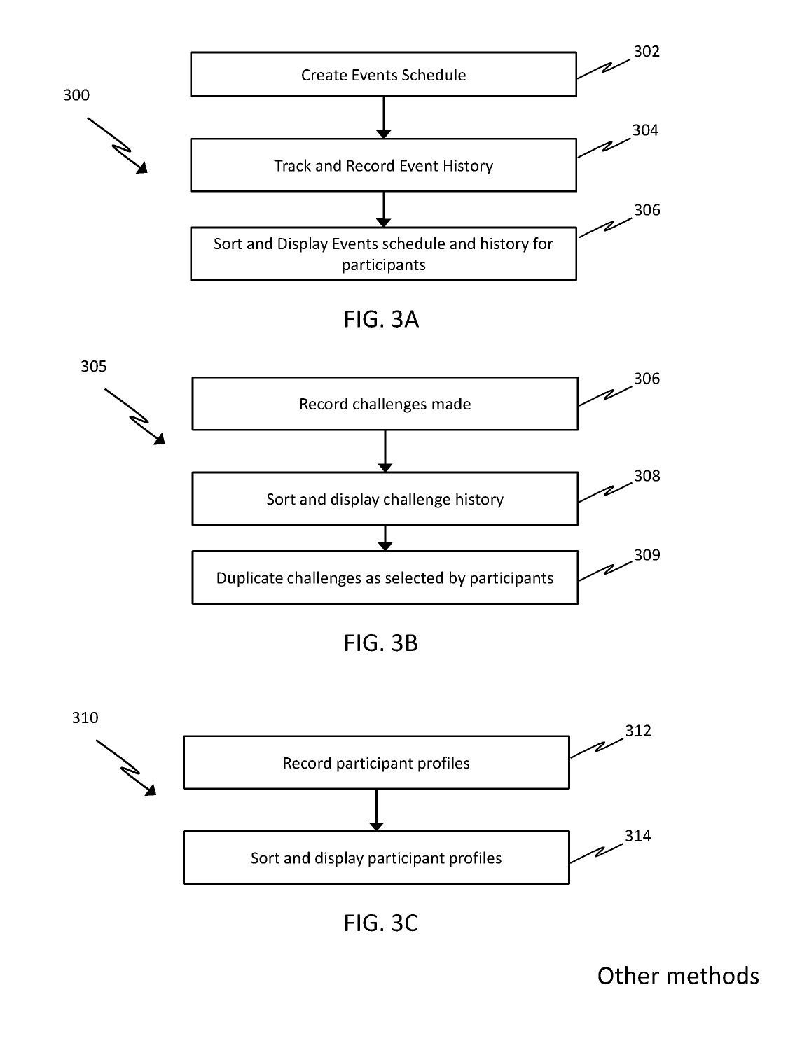

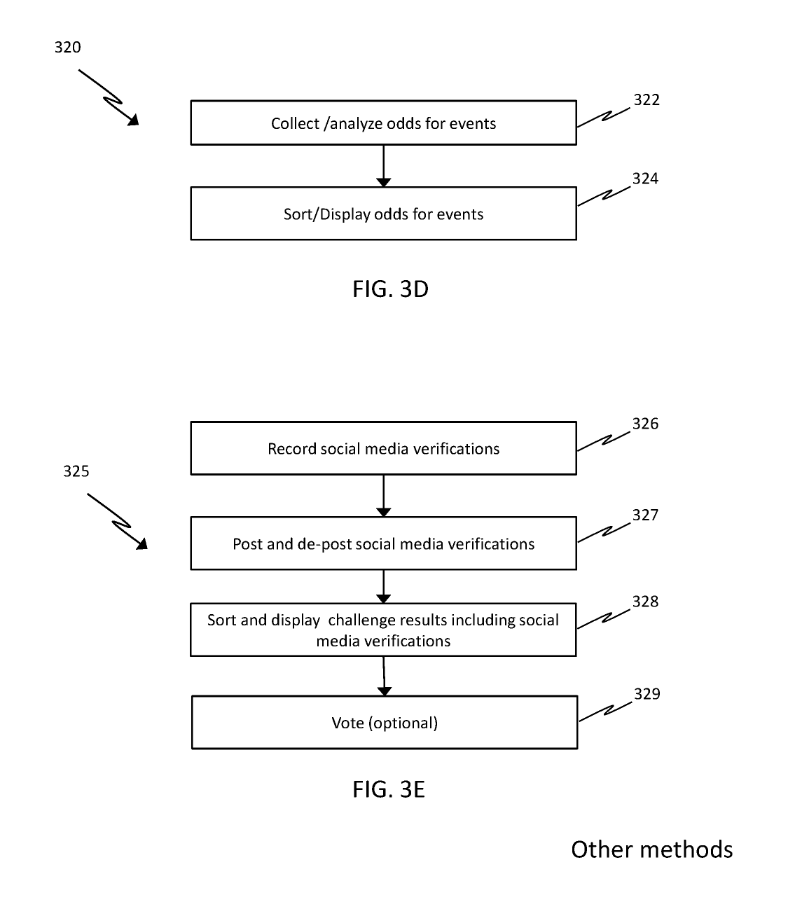

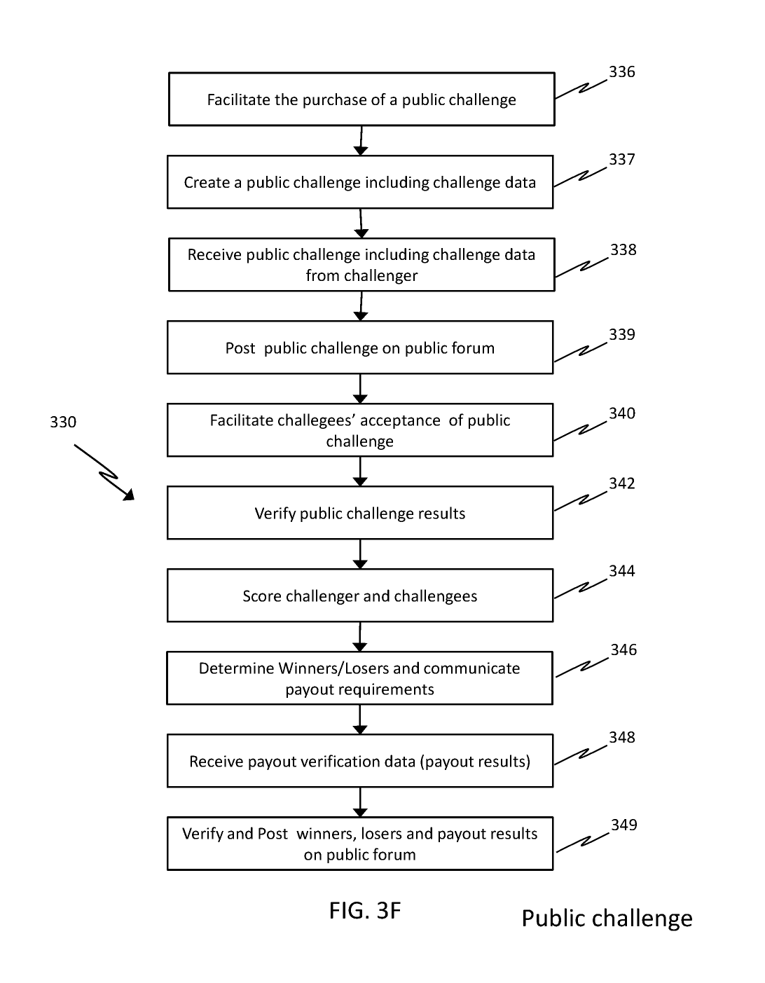

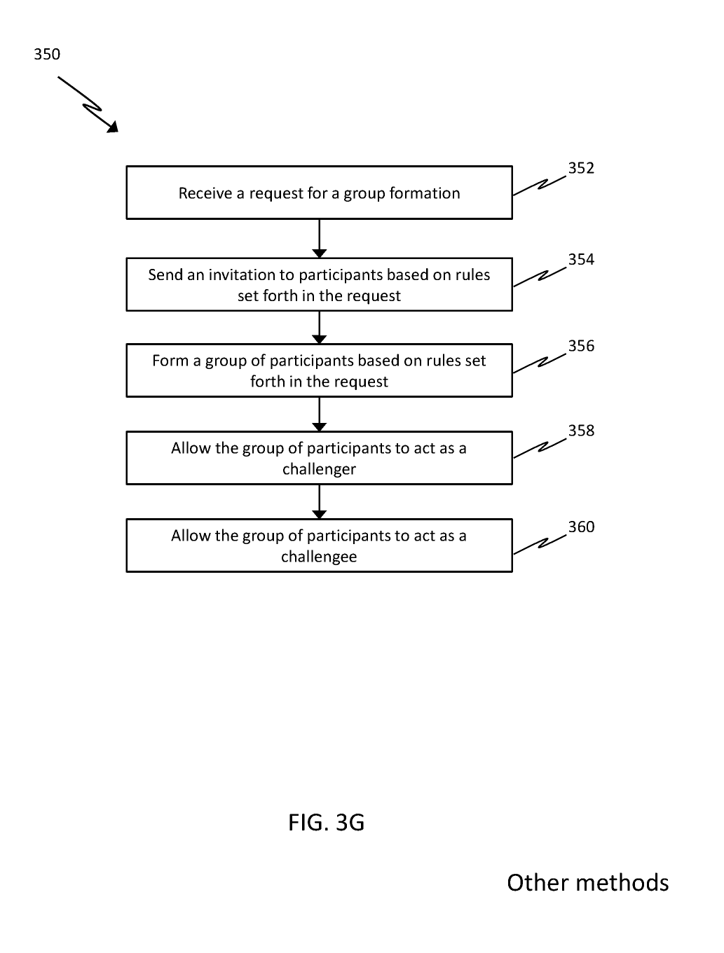

The disclosure provides methods for various aspects of the invention in FIGS. 3A through 3E. Referring to FIG. 3A, at step 302 the challenge system creates an events schedule from event information downloaded from the news and sports organizations. For example, the challenge system will compile the starting times and locations for every major league baseball game on opening day and every subsequent day of a major league baseball season. At step 304, the challenge system compiles a historical record of event results in an event history in the database. For example, the challenge system will compile the final scores of every major league baseball game on opening day and every subsequent day of the major league baseball season.

Referring to FIG. 3B, at step 306, the challenge system records the details of each challenge made between a challenger and a challengee and stores that challenge detail in the database as described previously in FIG. 6. At step 308, upon request of a registered participant, the challenge system sorts and displays the challenges. The challenges can be sorted and displayed by participant, by date, by event and in any other way possible via the information stored in each challenge. At step 310, a particular challenge may be duplicated from a previous challenge in the challenge history by creating a new challenge and incorporating the challenge detail from the previous challenge along with a new challenger and a new challengee.

Referring to FIG. 3C, at step 312, the challenge system records participant profiles at registration. At step 314, the challenge system sorts participant profiles based on profile information included in the participant profiles. In a preferred embodiment, the challenge system displays the sorted participant profiles to a secure system administrator. In an alternate embodiment, the challenge system sorts and communicates the sorted participant profiles to external agencies, such as advertising agencies. Advertising agencies produce and direct advertisements to participants through the challenge system. Alternatively, the advertising agencies produce advertisements for a specific demographic and the challenge system is programmed to determine which participants receive the advertisements rather than the advertising agencies making the determination.

Referring to FIG. 3D, a method 320 is shown for managing odds for event outcomes. At step 322, the challenge system queries and retrieves odds from the odds accumulator for a specific set of sports games or events. At step 324, upon a registered participant request, the odds for the specific set of sports games or events is sorted and displayed per the request. An example of an odds accumulator is “Norm's Clubhouse” which is accessed via the internet.

Referring to FIG. 3E, a method 325 is shown for social media verification. At step 326, social media information is received by the challenge system from participants and recorded in the database. At step 327, the social media information is posted on the challenge system website for a predetermined time period. After the predetermined time period, the social media information is removed from the website. While the social media information is posted, at step 328, the challenge system sorts and posts challenge results on the challenge system website. In an optional step, step 329, the challenge system provides a voting mechanism for participants to vote on whether a challenge has been completed and a payout requirement has been met while viewing the social media information.

Referring to FIG. 3F, method 330 is shown for a one to many public challenge using the challenge system (for example, the challenge system of FIG. 1). The object of method 330 is to allow a public forum for a challenge, an acceptance of a challenge, verification of challenge winners/losers and payout of a challenge.

Method 330 begins with the purchase of a public challenge at step 336. At step 337, a public challenge is created including challenge data. Step 337 is facilitated by the host server. In a preferred embodiment, step 337 is carried out by a participant interacting with the host server to select or create attributes of the public challenge such as an event time, an event location, a text description of the public challenge, a video related to the challenge, graphics/photos related to the challenge, participant requirements, challenge rules, challenge payout requirements and so forth. At step 338, a public challenge is received by a host server of the challenge system.

At step 339, the public challenge is posted on a public forum. In the preferred embodiment, the public forum is publically accessible website serviced by a web server and a host server. However, other public forums may be contemplated that utilize the inventive concept, such as interactive television, messaging systems on social media sites, social media platforms or any mechanism that allows a posting and display of the public challenge and the capture and communication of a response by a potential participant to the host server.

At step 340, the challenge system facilitates a set of challengees' acceptance of the public challenge. In step 340, the host server implements challenge rules and participant requirements set forth in the challenge data to allow acceptance by challengees and to determine the set of challengees. In a preferred embodiment, at step 340, the host server counts the number of participants in the set of challengees.

At step 342, the challenge system facilitates verification of the challenge results. Step 342 is carried out by receiving verification from the set of challengees and the challenger according to the challenge rules. For example, if the challenge relates to video verification of a particular action to be performed by a challenger or other entity, the video verification is received by the host server and analyzed. The analysis can be as simple as a human operator making a determination and entering the determination into the host server. In some situations, the analysis is performed automatically by the host server, for example, when a voting system is used in which a group of participants vote on the challenge.

At step 344, the challenge system assigns a score to the challenger and the challengees. In a preferred embodiment, the challenger score is dependent upon the number of challengees that accepted the challenge. In step 344, scoring is determined by the challenge rules. For example, scoring could be based on a set of times in a timed event, wherein a time is measured for the challenger and each challengee in a timed event and a score is created based on measured and verified times.

At step 346, winners and losers for the public challenge are determined by the challenge system and the payout requirements are communicated to participants (challenger and challengees). Winners and/or losers can be any subset of the participants as set forth in the challenge rules and payout requirements.

At step 348, the challenge system receives and organizes payout verification data (payout results). At step 349, the challenge system posts the winners, losers and payout requirements on the public forum, and posts payout results (payout verification) communicated to the challenge system in step 348.

Referring to FIG. 3G, method 350 for grouping participants is shown. At step 352, the challenge system receives a request for a group formation from a participant. The request includes at least a set of rules for forming a group of participants to act as a group entity, for example a challenger or a challengee, in the challenge system. At step 354, an invitation is sent to participants based on the set of rules set forth in the request. At step 356, a group of participants is formed into an entity based on the rules set forth in the request. In a preferred embodiment, in steps 352 and 356, the set of rules include an entity name for the group and the group is stored by the host server according to the entity name. By so doing, the group with the entity name can act as a challenger or challengee within the challenge system.

At step 358, the challenge system allows the group entity to act as a challenger—initiating and creating challenges and participant requirements for becoming a challengee and performing payout requirements.

At step 360, the challenge system allows the group entity to act as a challengee—accepting a challenge and performing payout requirements.

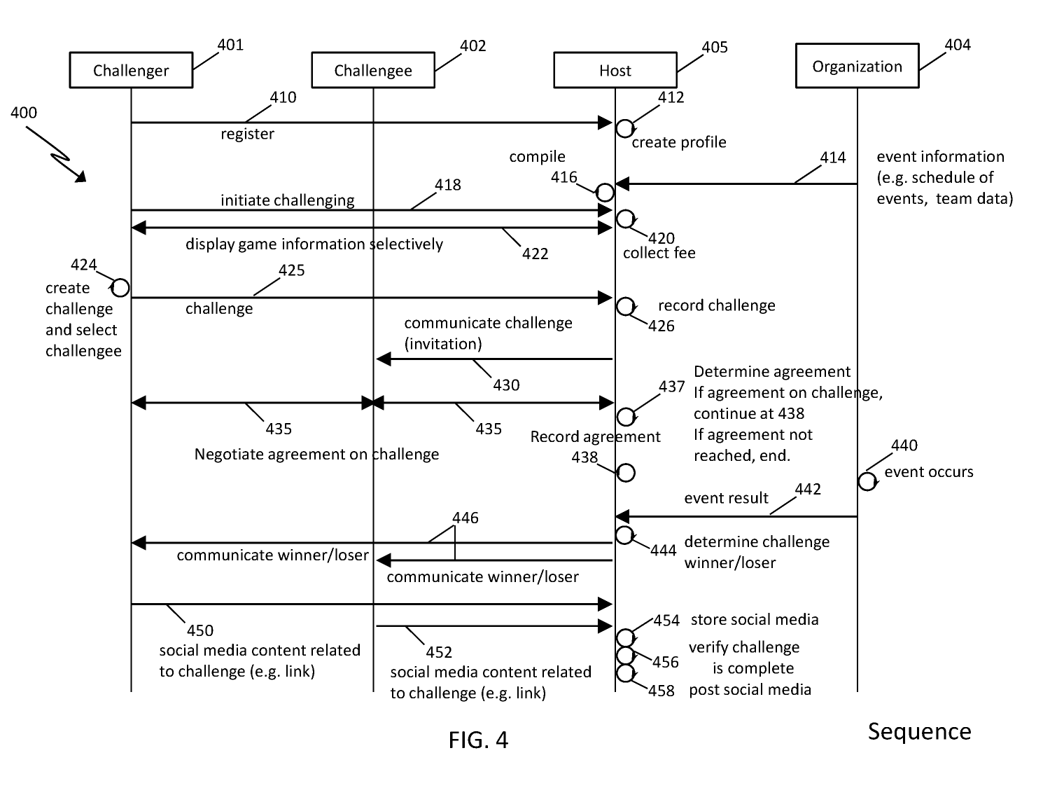

Referring to FIG. 4, a sequence diagram of process 400 shows the challenge system in operation between a challenger 401, a challengee 402, a host server 405 and an organization 404. The challenger 401 is synonymous with a challenger device and the challengee 402 is synonymous with a challengee device. Thus, an action performed by a challenger is an action carried out by the challenger device in communication with the host server and similar for the challengee. Host server 405 includes a database, a web server and a communications server such as an email server and/or SMS server.

In the sequence diagram vertical lines indicate time progression from top to bottom. Horizontal lines with arrows indicate interactions and data flow. Circles with arrows indicate computer processing steps.

In at least one embodiment, organization 404 is a sports organization. The sequence of process 400 is described below using sports related terms and event information for context. Other embodiments are not limited to sports organizations, sports related terms or sports related information. The present system and process 400 is applicable to other event related organizations, for example, an election results organization, a music concert or even a group of participants registered in the challenge system.

At step 410 a challenger interacts with the host server to register as a participant with the host server. At step 412, the host server creates a profile for the challenger including a user name and a password for secure authentication.

At step 414, the host server receives event information from organization 404, including, for example, a schedule of games, team data (players), team statistics and so forth. At step 415, the host server compiles the event information into a schedule that will be useful to the challengers for creating challenges.

At step 418, the challenger creates a challenge by interacting with the host server. At step 420, the host server facilitates the collection of a fee for issuing a number of challenge opportunities. At step 422, the event information is selectively sent to the challenger, based on challenger selections through interaction with the host server.

At step 424, the challenger selects a set of games or a game situation based on the game information and creates a challenge including challenge details as previously described (see for example, FIG. 6) and selects a challengee. At step 425, the challenge is communicated to the host server and, at step 426, recorded in the database of the host server.

At step 430, the challenge is sent to the challengee as an invitation. In a preferred embodiment, the invitation is sent as an email or a text message generated by the host server and sent out on the email server or SMS server included in the host server.

At step 435, the challenger and the challengee negotiate an agreement on the challenge with the aid of the host server. At step 437, the host server determines if agreement on the challenge is reached. If agreement on the challenge is reached, then process 400 continues at step 438 and subsequent steps. If agreement on the challenge is not reached, then process 400 is terminated.

At step 438 the agreement on the challenge is recorded and then steps.

At step 440, a sporting event occurs related to the challenge and, at step 442, the result of the sporting event is communicated to the host server by the organization.

At step 444, host server 405 determines the winner and loser of the challenge based on the challenge details defined at step 424. At step 446, winner and loser information, as determined at step 444, is communicated to the challenger and the challengee.

At step 450, the challenger sends social media content related to the challenge to the host server. At step 452, the challengee sends social media content related to the challenge to the host server. At step 454, the host server stores the social media content from the challenger and from the challengee.

At step 456, host server 405 verifies that all conditions for challenge verification included in the challenge details have been met. At step 458, the host server posts the social media content including the winner/loser results.

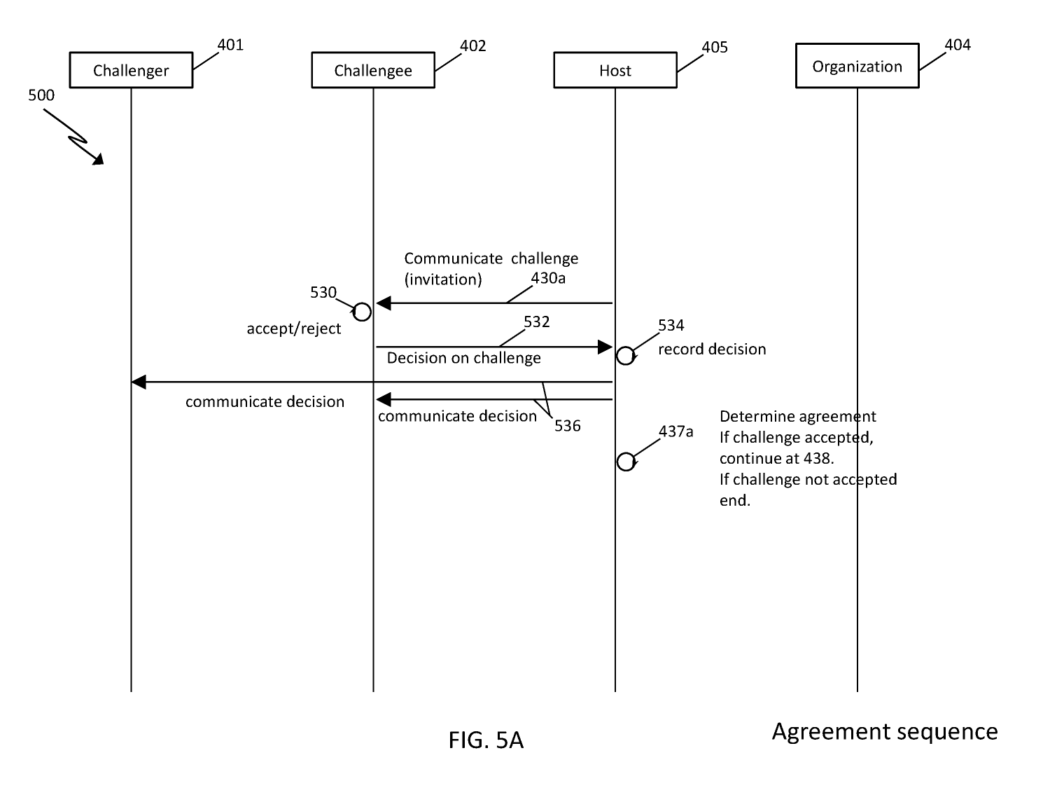

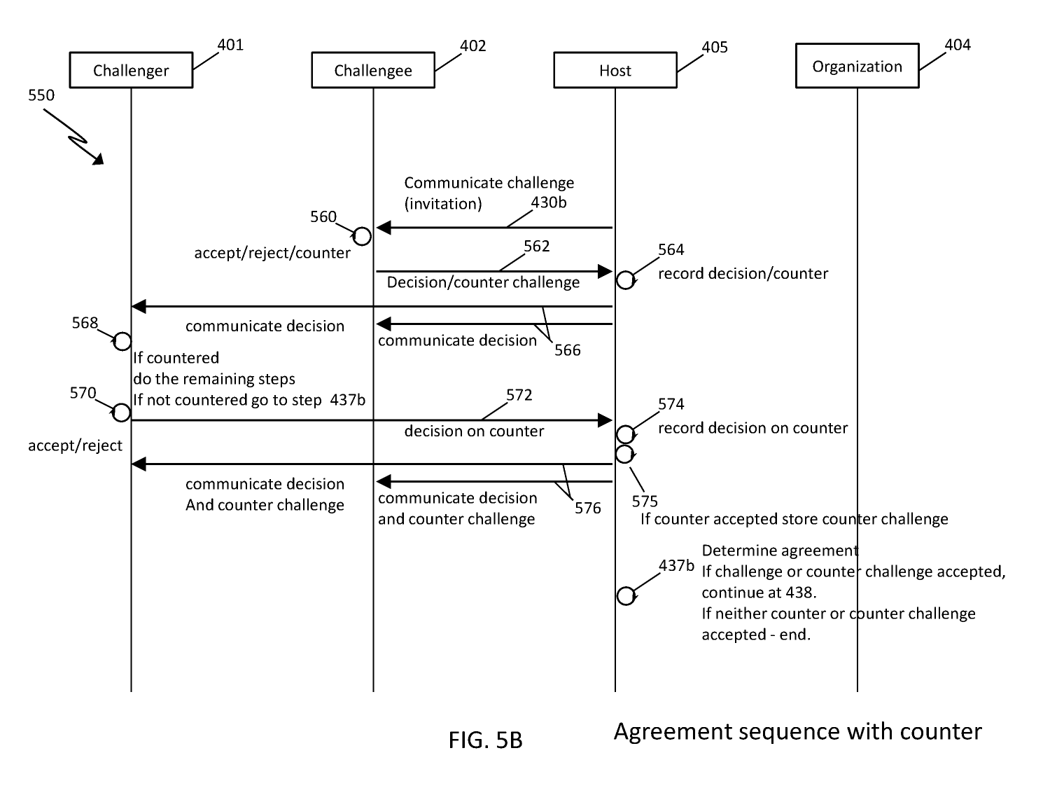

Referring to FIG. 5A, a sequence diagram shows process 500 of agreement between challenger 401, challengee 402, host server 405 and organization 404. Process 500 describes the details of step 435 of process 400 of FIG. 4 in a preferred embodiment.

At step 430a, the initial challenge is sent to the challengee as an invitation which can be accepted or rejected. In a preferred embodiment, the invitation is sent as an email or a text message generated by the host server and sent out on the email server or SMS server included in the host server.

At step 530, the challengee makes a decision to accept or reject the initial challenge. At step 532, the decision is communicated to the host server. At step 534, the decision is recorded in the database by the host server.

At step 536, the decision is communicated to the challenger and the challengee in a communication message.

At step 437a, the host server determines if an agreement on a challenge was made. If the initial challenge was accepted, then the agreement is considered to have been reached (and, in process 400, step 438 and subsequent steps are carried out). If the initial challenge was rejected, then agreement is considered not to have been reached (and processes 400 and 500 end).

Referring to FIG. 5B, a sequence diagram shows process 550 of agreement between challenger 401, challengee 402, host server 405 and organization 404 when countering of challenges is enabled and performed. Process 550 describes the details of step 435 of process 400 of FIG. 4 in an alternate embodiment.

At step 430b, the initial challenge is sent to the challengee as an invitation which can be accepted, rejected or countered. In a preferred embodiment, the invitation is sent as an email or a text message generated by the host server and sent out on the email server or SMS server included in the host server.

At step 560, the challengee makes a decision to accept, reject or counter the initial challenge. If the decision is to counter, then a counter challenge is created at step 560 by the challengee and sent to the host computer, in step 562, along with the decision. At step 564, the decision and counter challenge, if that is the case, is recorded in the database by the host server.

At step 566, the decision and counter challenge (if it exists) is communicated to the challenger and challengee in a communication message. At step 568, if the decision is to counter, then the remaining steps of process 550 beginning at step 570 are performed. Otherwise the process continues with step 437b.

At step 570, the challenger rejects or accepts the counter challenge and, at step 572, communicates that decision on the counter to the host server. At step 574, the host server records the decision on the counter and, at step 575, if the counter is accepted, records the counter challenge. At steps 576, the decision on the counter and the counter challenge is communicated to the challenger and to the challengee.

At step 437b, the host server determines if an agreement on a challenge was made. If the initial challenge was accepted or the counter challenge was accepted, then the agreement is considered to have been reached (and in process 400, step 438 and subsequent steps are carried out). If the initial challenge was rejected or the counter challenge was rejected, then agreement is considered not to have been reached (and processes 400 and 550 end).

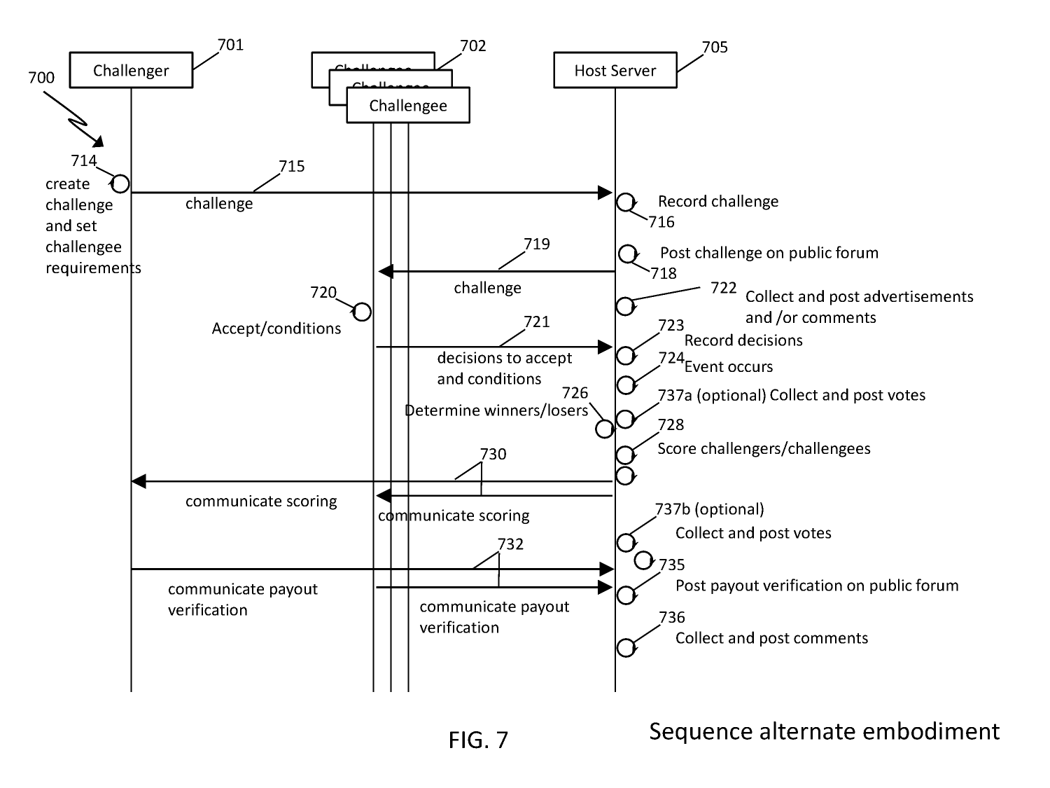

Referring to FIG. 7, a sequence diagram of process 700 shows the challenge system in operation between a challenger 701, a set of challengees 702 and a host server 705. The challenger 701 is synonymous with a challenger device and the set of challengees 702 is synonymous with a set of challengee devices. Thus, an action performed by a challenger is an action carried out by the challenger device in communication with the host server and similar for the set of challengees. Host server 705 includes a database, a web server and a communications server such as an email server and/or SMS server.

The process 700 is applicable to utilize event related organizations to determine event related data. The event related organizations are, for example, sports organizations, an election results organization, a music concert or even a group of participants registered in the challenge system.

At step 714, host server 705 facilitates the creation of a challenge by a challenger wherein a challenge is created, including challenge data, a set of challenge rules and, at least, an invitation rule for determining which participants are allowed to participate in the challenge. The challenge data includes at least an event with an event time and location and a payout requirement. At step 715 the challenge is communicated to the host server and at step 716, the challenge is received and recorded in a database.

At step 718, the challenge is posted on a public forum and at step 719, the challenge is communicated to the set of challengees. In a preferred embodiment, the public forum is a publically accessible website. Other public forums may be contemplated that utilize the inventive concept, such as interactive television, messaging systems on social media sites, social media platforms or any mechanism that allows a posting and display of the public challenge and the capture and communication of a response by a potential participant to the host server.

At step 720, the challenge is accepted by the set of challengees (decisions to accept) and conditions of acceptance, if allowed in the set of challenge rules, are determined. At step 721, the decisions to accept and the conditions of acceptance are communicated o the host server. At step 723 decisions to accept and the conditions of acceptance are recorded in a database by the host server.

At step 722, the host server collects comments and advertisements and thereafter posts the comments and advertisements on the public forum. The comments and advertisements are related to the challenge. In a preferred embodiment, the challenge data included with the challenge can include a set of advertisements or an advertiser to whom the host server may communicate to collect advertisements related to the challenge.

At step 724, the event occurs related to the challenge and at step 726, the host server determines winners and losers.

At step 728, challengers and challengees are scored based on the set of challenge rules. At step 730, the winners, losers, scores and the payout requirement are communicated to the challenger and the set of challengees. In a preferred embodiment, a challenger score is dependent upon the number of challengees in the set of challengees. In step 730, scoring is determined by the set of challenge rules. For example, scoring could be based on a set of times in a timed event, wherein a time is measured for the challenger and each challengee in a timed event and a score is created based on measured and verified times.

The challenge system facilitates verification of the challenge results. At step 732, payout verification of the payout requirement is received by the host server from the challenger and the set of challengees. At step 735, the host server facilitates payout verification and posts payout verification on the public forum.

Step 735 is carried out according to the challenge rules. For example, if the payout requirement includes video verification of a particular action to be performed then video verification is received from the challenger, set of challengees or other entities. The video verification is further analyzed by the host. The analysis can be as simple as a human operator making a determination and entering the determination into the host server. In some situations, the analysis is performed automatically by the host server, for example, when a voting system is used in which a group of participants vote on the whether the payout requirement has been met.

At step 736, the host server collects comments and advertisements and thereafter posts the comments and advertisements on the public forum. The comments and advertisements are related to the challenge payout. In a preferred embodiment, the challenge data included with the challenge can include a set of advertisements or an advertiser to whom the host server may communicate to collect advertisements related to the challenge payout.

In an alternate embodiment, at steps 737a and 737b, the host server collects votes from the public forum, tallies votes and posts vote tallies on the public forum. In one alternate embodiment, the votes from step 737a are used to determine the winners and losers. In another alternate embodiment, the votes from step 737b are used to verify the payout requirement.

It will be appreciated by those skilled in the art that the described embodiments disclose significantly more than an abstract idea including technical advancements in the field of data processing and a transformation of data which is directly related to real world objects and situations in that the disclosed embodiments enable a computer to operate more specifically for improvements to social media communications. The disclosed embodiments provide a new mechanism for creating and facilitating a social interaction with challenge games not previously contemplated. A challenger (entity that initiates a challenge) is not limited to one person, but may be an entity such as a corporation or a group of participants. Similarly a challengee (entity that receives a challenge) is not limited to one person, but may be an entity such as a corporation or a group of participants.

It will be appreciated by those skilled in the art that changes could be made to the embodiments described above without departing from the broad inventive concept. It is understood, therefore, that this disclosure is not limited to the particular embodiments herein, but it is intended to cover modifications within the spirit and scope of the present disclosure.

1. A challenge system for managing and verifying challenges between a first participant and a second participant, wherein a challenge is defined by a set of challenge rules, a condition for verification and a payout requirement, the challenge system comprising:
a host server;
a database communicatively connected to the host server and configured to record the set of challenge rules and the payout requirement;
a web server communicatively connected to the host server and configured to communicate with first participant and the second participant;
the host server further configured to execute the steps of:
registering the first participant;
facilitating the creation of a challenge including the set of challenge rules and the payout requirement;
communicating the challenge to the second participant;
determining a challenge result based on the set of challenge rules and the condition for verification;
communicating the challenge result to the first participant and the second participant; and,
verifying that the challenge is completed and the payout requirement is met.

2. The challenge system of claim 1, wherein the host server is further configured to facilitate the purchase of a challenge opportunity.

3. The challenge system of claim 1, wherein the host server is further configured to execute the steps of:
posting the challenge on a public website; and,
facilitating the acceptance of the challenge by the second participant.

4. The challenge system of claim 3, wherein the host server is further configured to execute the step of verifying that the challenge is completed and the payout requirement is met by using the public website.

5. The challenge system of claim 1, wherein the host server is further configured to execute the steps of:
recording a set of challenges and a set of challenge results in a challenge history in the database;
sorting and communicating the challenge history to at least one of the first participant and the second participant; and,
creating the challenge by duplicating any one of the set of challenges from the challenge history.

6. The challenge system of claim 1, wherein the host server is further configured to execute the steps of:
recording a set of social media information related to verifying the challenge;
posting the set of social media information on a public forum; and,
sorting and posting the challenge results on the public forum.

7. The challenge system of claim 1, wherein the host server is further configured to execute the steps of:
collecting and tallying a vote via a public forum; and,
using the vote to determine at least one of:
the challenge result; and,
if the payout requirement was met.

8. A method for challenging implemented in a challenge system having a host server and a webserver connected to the host server, the method comprising the steps of:
registering a first participant using the host server;
creating a challenge between the first participant and a second participant wherein the challenge specifies a set of challenge rules and a payout requirement;
recording the challenge in the challenge system via the host server;
communicating the challenge to the second participant from the challenge system;
determining a challenge result based on the set of challenge rules using the host server;
communicating the challenge result from the challenge system to the first participant and the second participant; and,
verifying that the payout requirement is met.

9. The method of claim 8 further comprising the step of facilitating the purchase of challenge opportunities.

10. The method of claim 8 wherein the step of recording the challenge further comprises recording the challenge in a challenge history and wherein the step of creating a challenge further comprises duplicating a challenge from the challenge history.

11. The method of claim 8 further comprising the steps of:
collecting a set of odds information for a set of events from an odds accumulator;
sorting the set of odds information; and
wherein the step of creating the challenge includes substeps of sorting the odds information and displaying the odds information for the first participant.

12. The method of claim 8 further comprising the steps of:
recording a set of social media verifications of the challenge results;
posting the set of social media verifications on a website;
sorting the challenge results; and,
displaying the challenge results on the website.

13. The method of claim 8 wherein the step of determining a challenge result includes the step of collecting votes related to the challenge via the website.

14. The method of claim 8 further comprising the steps of:
receiving a request to form a group of participants;
forming a group of participants based on the set of rules specified in the request; and,
facilitating the group of participants to act as the first participant in the challenge system.

15. The method of claim 8 further comprising the steps of:
receiving a request to form a group of participants;
forming a group of participants based on the set of rules specified in the request; and,
facilitating the group of participants to act as the second participant in the challenge system.

16. A method for challenging implemented in a challenge system having a host server communicatively connected to a public forum, the method comprising the steps of:
creating a public challenge between a first participant and a set of participants wherein the challenge specifies a set of challenge rules, a participant requirement and a payout requirement;
posting the public challenge on the public forum via the host server;
facilitating the acceptance of the public challenge by the set of participants;
determining a set of winners and a set of losers taken from the first participant and the set of participants;
communicating the payout requirement to the first participant and the set of participants;
receiving a set of payout verification data into the host server via the public forum; and,
verifying that the payout requirement is met using the set of payout verification data.

17. The method of claim 16 further comprising the step of posting the set of winners and the set of losers on the public forum.

18. The method of claim 16 further comprising the step of posting the set of payout verification data on the public forum.

19. The method of claim 18 further comprising the step of collecting a vote via the public forum to determine that the payout requirement is met.

20. The method of claim 16 further comprising the step of assigning a first score to the first participant and a second score to the set of participants wherein the first score and the second score are assigned as specified in the set of challenge rules.
